(19) United States
(12) Patent Application Publication
(10) Pub. No.: US 2019/0254471 A1
(43) Pub. Date: Aug. 22, 2019

(54) COOKING VESSEL FOR AN OVEN CAVITY OF A COOKING OVEN

(71) Applicant: ELECTROLUX APPLIANCES AKTIEBOLAG, Stockholm (SE)

(72) Inventors: Fabienne REINHARD-HERRSCHER, Schnelldorf (DE); Christoph LUCKHARDT, Rothenberg ob der Tauber (DE)

(21) Appl. No.: 16/340,312

(22) PCT Filed: Sep. 13, 2017
(86) PCT No.: PCT/EP2017/073033

§ 371 Date: Apr. 8, 2019

(30) Foreign Application Priority Data
Oct. 11, 2016 (EP) 16193383.3

(51) Int. Cl. A47J 36/02; A47J 36/32

(52) U.S. Cl. CPC A47J 36/02; A47J 2202/00; A47J 36/32

(57) ABSTRACT

The present invention relates to a cooking vessel (14) for an oven cavity (12) of a cooking oven (10). The cooking vessel (14) includes an upper part (16) and a lower part (18). The cooking vessel (14) provides a closed space, when the upper part (16) covers the lower part (18). The upper part (16) and the lower part (18) are made of at least one temperature resistant polymer or plastic. At least one temperature sensor (22) is removably or permanently arranged in the bottom of the lower part (18). The temperature sensor (22) is connectable or connected to a control unit of the cooking oven (10). Further, the present invention relates to a cooking oven (10) connectable to a cooking vessel (14) arranged in an oven cavity (12) of said cooking oven (10).

Cooking vessel for an oven cavity of a cooking oven The present invention relates to a cooking vessel for an oven cavity of a cooking oven. Further, the present invention relates to a cooking oven with an oven cavity and at least one cooking vessel.

The cooking process in a casserole within an oven cavity has relative high energy consumption. The casserole is usually made of material having high heat capacity. Further, the control of the cooking process in the casserole is difficult.

It is an object of the present invention to provide a cooking vessel for an oven cavity of a cooking oven, which allows reduced energy consumption and an improved control of the cooking process.

The object is achieved by the cooking vessel for an oven cavity of a cooking oven according to claim 1.

According to the present invention a cooking vessel for an oven cavity of a cooking oven is provided, wherein:
the cooking vessel includes an upper part and a lower part,
the cooking vessel provides a closed space, when the upper part covers the lower part,
the upper part and the lower part are made of at least one temperature resistant polymer or plastic,
at least one temperature sensor is removably or permanently arranged in the bottom of the lower part, and
the temperature sensor is connectable or connected to a control unit of the cooking oven.

The core of the present invention is that the cooking vessel is made of the temperature resistant polymer or plastic on the one hand and the arrangement of the temperature sensor in said cooking vessel on the other hand, wherein the temperature sensor is connectable or connected to the control unit of the cooking oven. The cooking process in the cooking vessel can be directly controlled.

Preferably, the temperature sensor is connectable or connected to an oven socket via a cable, so that the temperature sensor can communicate with the control unit of the cooking oven.

In particular, the lower part comprises a vessel socket for receiving a food probe including the temperature sensor, wherein said vessel socket is formed in the bottom of the lower part.

Alternatively, the lower part may comprise a socket for receiving an electric plug of the cable, wherein said socket is connected to the temperature sensor, and wherein preferably the temperature sensor is permanently or detachably arranged in the bottom of the lower part.

According to a further alternative embodiment, the lower part is hard-wired with the cable, wherein preferably the cable includes a plug connectable to the oven socket of the cooking oven.

According to another alternative embodiment, the temperature sensor is connectable or connected to the control unit of the cooking oven via a wireless connection, for example an SAW or RFID connection.

For example, the upper part and the lower part include a planar contact surface in each case, so that the upper part and the lower part are tightly closable together by gravity, wherein preferably the upper part and/or the lower part include a rim, which prevents the upper part from getting out of place.

Alternatively, the upper part and the lower part may include an interlocking system, wherein preferably at least one sealing is arrangeable or arranged between the upper part and the lower part.

For example, the upper part and the lower part include a bayonet closing system between said upper part and lower part.

According to another example, the upper part and the lower part are connectable or connected by ate least one clamp and/or hinge.

Further, the cooking vessel may include at least one automatic and/or manual pressure release system, wherein preferably said pressure release system limits the pressure inside the cooking vessel.

Moreover, the cooking vessel may include at least one lockable opening for controlling the loss of moisture in the cooking vessel, wherein preferably said lockable opening is a rotatable slider or a linearly movable slider.

Preferably, the cooking vessel comprises at least one ventilation opening including the lockable opening and the pressure release system mentioned above.

Further, the present invention relates to a cooking oven with an oven cavity and at least one cooking vessel mentioned above, wherein
the oven cavity is provided for receiving the cooking vessel,
the cooking oven includes at least one oven socket for receiving a plug of the cable connected or connectable to the at least one temperature sensor of the cooking vessel, and
the oven socket is connected to the control unit of the cooking oven.

At last, the present invention relates to an alternative cooking oven with the oven cavity and at least one cooking vessel mentioned above, wherein
the oven cavity is provided for receiving the cooking vessel,
the cooking oven includes means for at least one wireless connection to the at least one temperature sensor of the cooking vessel, and
the means for the wireless connection are connected to the control unit of the cooking oven.

Novel and inventive features of the present invention are set forth in the appended claims.

The present invention will be described in further detail with reference to the drawings, in which

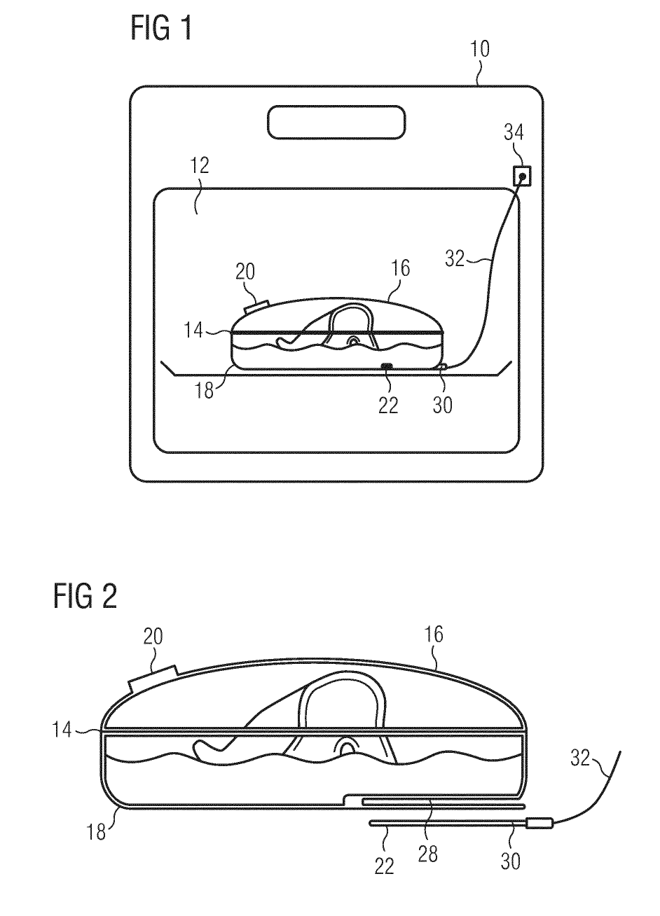

FIG. 1 illustrates a schematic front view of a cooking oven with a cooking vessel according to a preferred embodiment of the present invention,

FIG. 2 illustrates a schematic front view of the cooking vessel according to the preferred embodiment of the present invention,

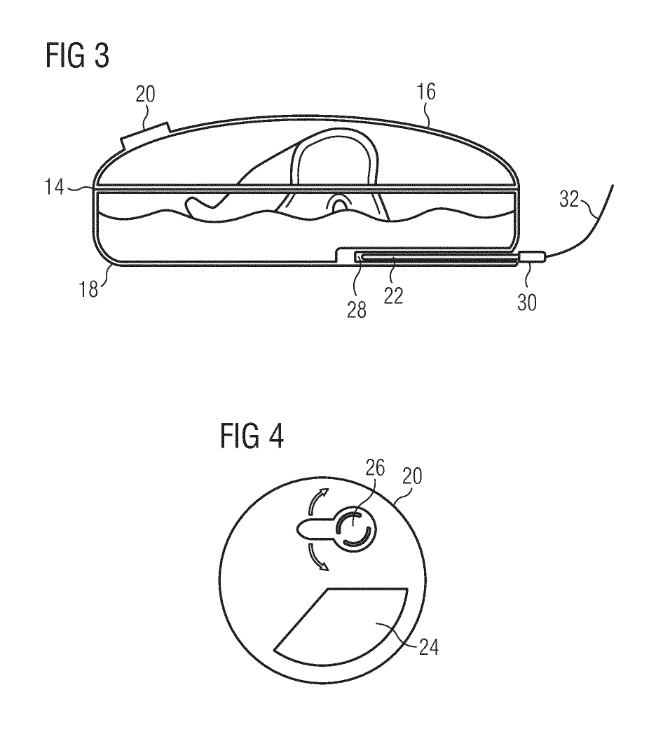

FIG. 3 illustrates a schematic front view of the cooking vessel according to the preferred embodiment of the present invention, and

FIG. 4 illustrates a schematic top view of a ventilation opening of the cooking vessel according to the preferred embodiment of the present invention.

FIG. 1 illustrates a schematic front view of a cooking oven 10 with a cooking vessel 14 according to a preferred embodiment of the present invention. The cooking vessel 14 is arranged inside an oven cavity 12 of the cooking oven 10.

The cooking vessel 14 includes an upper part 16 and a lower part 18. The upper part 16 and the lower part 18 form the closed cooking vessel 14. In this example, the lower part 18 is a casserole, while the upper part 16 is a lid. The cooking vessel 14 includes a temperature sensor 22. In this example, the temperature sensor 22 is arranged in the bottom of the lower part 18. Preferably, the temperature sensor 22 is an NTC resistor element. The temperature sensor 22 is a part of a food probe 30 received by a vessel socket 28 in the bottom of the lower part 18. The food probe 30 with temperature sensor 22 is connected to an oven socket 34 of the cooking oven 10 via a cable 32.

In this example, the upper part 16 and the lower part 18 include a planar contact surface in each case. Said planar contact surfaces allow a tight closing between the upper part 16 and the lower part 18 by gravity. Preferably, the upper part 16 and/or the lower part 18 include a rim, which prevents the upper part 16 from getting out of place. Alternatively, the upper part 16 and the lower part 18 include an interlocking system, for example a bayonet closing system, clamps and/or hinges, wherein preferably a sealing is arranged between the upper part 16 and the lower part 18.

Further, the cooking vessel 14 comprises a ventilation opening 20 arranged in a top side of the upper part 16. Said ventilation opening 20 is optional, if the upper part 16 and the lower part 18 include the planar contact surfaces. However, the ventilation opening 20 is necessary or at least advantageous, if the upper part 16 and the lower part 18 include the interlocking system.

The cooking vessel 14 is made of at least one temperature resistant polymer or plastic, for example of at least one of Liquid crystal polymere (LCP), Polyether-etherketon (PEEK) and/or Polyetherimid (PEI). Said polymer or plastic has a low heat capacity. More accurately, the heat capacity per volume of the polymer is low. The material of the cooking vessel 14 is food safe. The material of the cooking vessel 14 has an emissivity of at least 0.8, preferably bigger than about 0.8, which is a low value and contributes to low energy consumption. In particular, the emissivity can be between selected from the range of 0.8 to 1.

The cooking vessel 14 is provided for different sizes. For example, the volume of the cooking vessel 14 is one, two three, five or seven litre.

FIG. 2 illustrates a schematic front view of the cooking vessel 14 according to the preferred embodiment of the present invention. The upper part 16 and the lower part 18 form the closed cooking vessel 14.

A vessel socket 28 is integrated in the bottom of the lower part 18. The vessel socket 28 is provided for receiving the food probe 30 with the temperature sensor 22. In FIG. 2 the food probe 30 is outside of the vessel socket 28. The food probe 30 is connectable via the cable 32 to the oven socket 34 of the cooking oven 10, so that the temperature sensor 22 is connectable to a control unit of the cooking oven 10. The cable 32 is connectable to the oven socket 34 via a plug. For example, the plug for the oven socket 34 is a 3.5 mm or 6.35 mm phone jack.

FIG. 3 illustrates a schematic front view of the cooking vessel 14 according to the preferred embodiment of the present invention. In FIG. 3 the food probe 30 is inserted in the vessel socket 28.

According to another embodiment, the lower part 18 includes a socket for a phone jack or the like in order to connect the cooking vessel 14 to the control unit of the cooking oven 10. In this case, the temperature sensor 22 is permanently or detachably arranged in the bottom of the lower part 18 and electrically connected to the socket.

According to a further embodiment, the lower part 18 is hardwired with the cable 32. In this case, the cable 32 may include a plug, e.g. a jack phone, connectable to the oven socket 34 of the cooking oven 10.

Alternatively, the food probe 30 with the temperature sensor 22 is connectable to the control unit of the cooking oven 10 via a wireless connection, for example SAW, RFID or the like. If the cooking oven 10 is equipped with a camera, then an analogue temperature gauge is possible. Said temperature gauge may be monitored via camera and application software.

FIG. 4 illustrates a schematic top view of the ventilation opening 20 of the cooking vessel 14 according to the preferred embodiment of the present invention. The ventilation opening 20 is optional, if the upper part 16 and the lower part 18 include the planar contact surfaces. In contrast, the ventilation opening 20 is necessary or at least advantageous, if the upper part 16 and the lower part 18 include the bayonet closing system, the clamps and/or the hinges.

The ventilation opening 20 comprises a rotatable slider 24 and a pressure release system 26. Instead of the rotatable slider 24 the ventilation opening 20 may comprise a linearly movable slider. The rotatable slider 24 allows different opening widths. The rotatable slider 24 controls the loss of moisture in the cooking vessel 14 during the cooking process. The pressure release system 26 allows an automatic and/or manual reduction of an overpressure inside the closed cooking vessel 14. Moreover, the pressure inside the cooking vessel 14 can be reduced to ambient pressure after the cooking process.

The present invention provides a light weight cooking vessel 14 with a low heat capacity. The tight closing of the upper part 16 and the lower part 18 prevents the food from moisture loss. The interlocking system for the upper part 16 and the lower part 18 allows pressure cooking modes. The pressure release system 26 of the ventilation opening 20 allows the automatic limitation of the pressure inside the cooking vessel 14. The rotatable slider 24 of the ventilation opening 20 allows the possibility to get rid of moisture, if the cooking recipe requires this.

The integrated temperature sensor 22 allows an automatic and/or manual control of the cooking process. The temperature control during pressure cooking prevents a continuous pressure release. Using application software and the temperature sensor 22 the user can monitor the cooking process in an easy way. Food usually cooked in a pot on a cooking hob may be prepared in the cooking vessel 14 inside the oven cavity 12 in a shorter time. By the temperature control in the cooking vessel 14 vitamins and nutrients may be kept and energy is saved. Further, temperature dependent cooking processes like enzymatic degradation of collagen, hydrolysing of collagen, swelling of starch or denaturation of protein are supported by the temperature control in the cooking vessel 14. Moreover, the temperature control in the cooking vessel 14 allows the determination of the amount of food without scale.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 cooking oven
12 oven cavity
14 cooking vessel
16 upper part
18 lower part
20 ventilation opening
22 temperature sensor
24 rotatable slider
26 pressure release system
28 vessel socket
30 food probe
32 cable
34 oven socket

1. A cooking vessel for an oven cavity of a cooking oven, wherein:
the cooking vessel includes an upper part and a lower part,
the cooking vessel provides a closed space, when the upper part covers the lower part,
the upper part and the lower part are made of at least one temperature resistant polymer or plastic,
at least one temperature sensor is removably or permanently arranged in the bottom of the lower part, and
the temperature sensor is connectable or connected to a control unit of the cooking oven.

2. The cooking vessel according to claim 1, wherein the temperature sensor is connectable or connected to an oven socket via a cable, so that the temperature sensor can communicate with the control unit of the cooking oven.

3. The cooking vessel according to claim 2, wherein the lower part comprises a vessel socket for receiving a food probe including the temperature sensor, wherein said vessel socket is formed in the bottom of the lower part.

4. The cooking vessel according to claim 2, wherein the lower part comprises a further socket for receiving an electric plug of the cable, wherein said further socket is connected to the temperature sensor, and wherein the temperature sensor is permanently or detachably arranged in the bottom of the lower part.

5. The cooking vessel according to claim 2, wherein the lower part is hard-wired with the cable, wherein the cable includes a plug connectable to the oven socket of the cooking oven.

6. The cooking vessel according to claim 1, wherein the temperature sensor is connectable or connected to the control unit of the cooking oven via a wireless connection.

7. The cooking vessel according to claim 1, wherein each said upper part and lower part includes a respective planar contact surface, so that the upper part and the lower part are tightly closable together by gravity.

8. The cooking vessel according to claim 1, wherein the upper part and the lower part include an interlocking system.

9. The cooking vessel according to claim 8, wherein the upper part and the lower part include a bayonet closing system between said upper part and lower part.

10. The cooking vessel according to claim 8, wherein the upper part and the lower part are connectable or connected by ate least one clamp and/or hinge.

11. The cooking vessel according to claim 1, wherein the cooking vessel includes at least one automatic and/or manual pressure release system that limits pressure inside the cooking vessel.

12. The cooking vessel according to claim 1, wherein the cooking vessel includes at least one lockable opening for controlling loss of moisture in the cooking vessel.

13. The cooking vessel according to claims 11, wherein the cooking vessel comprises at least one ventilation opening including a lockable opening and the pressure release system.

14. A cooking oven with an oven cavity and the cooking vessel according to claim 1, wherein:
the oven cavity is provided for receiving the cooking vessel,
the cooking oven includes at least one oven socket for receiving a plug of the cable connected or connectable to the at least one temperature sensor of the cooking vessel, and
the oven socket is connected to the control unit of the cooking oven.

15. A cooking oven with an oven cavity and the cooking vessel according to claim 1, wherein:
the oven cavity is provided for receiving the cooking vessel,
the cooking oven includes means for at least one wireless connection to the at least one temperature sensor of the cooking vessel, and
the means for the wireless connection are connected to the control unit of the cooking oven.

16. The cooking oven according to claim 7, wherein the upper part and/or the lower part include(s) a rim, which prevents the upper part from getting out of place.

17. The cooking oven according to claim 12, said lockable opening being a rotatable slider or a linearly movable slider.

18. A cooking assembly comprising:
a cooking oven comprising an oven cavity and a controller for controlling a cooking process in said cavity;
a cooking vessel received within the oven cavity, the cooking vessel comprising a casserole and a lid covering and mated to the casserole to define a closed cooking space of the cooking vessel, said lid and said casserole both being made of at least one temperature resistant polymer comprising liquid crystal polymer, polyetheretherketone and/or polyetherimid; and
and a temperature sensor being located in or adjacent said casserole and being configured to detect a temperature of food cooked or cooking within said closed cooking space, said temperature sensor being connected with said controller in order that said controller is adapted and operable to automatically monitor and directly control the cooking process based on temperatures measured within said cooking space.

19. The cooking assembly according to claim 18, further comprising a food probe that comprises said temperature sensor, said casserole comprising a vessel socket, said food probe being removably inserted in said vessel socket such that said temperature sensor is removably received in said casserole via the vessel socket, said cooking oven comprising an oven socket, and a cable connecting said food probe to said oven socket in order to establish the connection between said temperature sensor and said controller.

20. The cooking assembly according to claim 19, said lid being locked to said casserole via an interlocking system thereby locking said cooking volume closed, wherein a seal is disposed between said lid and said casserole to preserve a pressure tight seal therebetween when locked.
